(19) United States
(12) Patent Application Publication
(10) Pub. No.: US 2012/0132800 A1
(43) Pub. Date: May 31, 2012

(54) VACUUM SYSTEM

(75) Inventor: Ian David Stones, Burgess Hill (GB)

(73) Assignee: EDWARDS LIMITED, Crawley, West Sussex (UK)

(21) Appl. No.: 13/389,087

(22) PCT Filed: Mar. 30, 2010
(86) PCT No.: PCT/GB2010/050533

§ 371 Date: Feb. 6, 2012

(30) Foreign Application Priority Data
Aug. 14, 2009 (GB) 0914221.7

(51) Int. Cl. H01J 49/24; F04B 23/08

(52) U.S. Cl. 250/288; 417/205

(57) ABSTRACT

The invention provides a vacuum system (12) comprising a plurality of vacuum chambers (14, 16, 18, 20) connected in series and a vacuum pumping arrangement (10) for differential pumping the chambers. The vacuum pumping arrangement comprises a primary pump (22) having an inlet (23) connected for pumping a first vacuum chamber (14) and an outlet (25) for exhausting at or around atmosphere, a booster pump (24) having an inlet (27) connected for pumping a second vacuum chamber (16) and an outlet (29) connected to the inlet (23) of the primary pump; and a secondary pump (26, 28) having an inlet (31, 33) connected for pumping a third vacuum chamber (18, 20) and an outlet (35, 37) connected to the inlet (27) of the booster pump.

The present invention relates to a vacuum system, for example a mass spectrometer system, comprising a plurality of vacuum chambers connected in series and a vacuum pumping arrangement for differential pumping the chambers.

A vacuum pumping arrangement 100 known hereto is shown in FIG. 2. The pumping arrangement 100 is for differentially pumping a plurality of vacuum chambers in a vacuum system such as a mass spectrometer system 102. The vacuum chambers are connected in series to provide a sample flow path from a high pressure (low vacuum) chamber 104 through an intermediate pressure chamber 106 to a low pressure (high vacuum) chamber 108. Typically, a low pressure chamber may be maintained at 1 mbar, an intermediate pressure chamber may be maintained at 10⁻³ mbar and a low pressure chamber may be maintained at 10⁻⁶ mbar. The vacuum pumping arrangement 100 is designed to differentially pump the vacuum chambers and maintain sample flow rate through the mass spectrometer. An increased sample flow rate through the mass spectrometer allows a greater amount of sample to be tested.

The vacuum pumping arrangement 100 comprises two primary (backing) pumps and two secondary pumps. The first and second secondary pumps 110, 112 may be turbomolecular pumps. The secondary pumps are arranged in parallel and are connected for pumping vacuum chambers 106, 108 respectively. The secondary pumps are connected in series with a primary, or backing, pump 114. As the secondary pumps are molecular pumps and cannot exhaust to atmosphere, the primary pump 114 is connected to the exhausts of the secondary pumps and the primary pump exhausts to atmosphere. In this way, the primary pump backs the secondary pumps. The primary pump may be for example a scroll pump.

A second primary pump is connected to the low vacuum chamber 104 and exhausts to atmosphere.

It is desirable to increase pumping speeds (and sample gas flow) without significantly increasing power requirement of the pumping arrangement in for example scientific systems such as mass spectrometers in order to enhance the performance of the systems, particularly in vacuum chambers having non-molecular, or viscous, flow regimes greater than about 1 mbar.

The present invention provides a vacuum system comprising a plurality of vacuum chambers connected in series and a vacuum pumping arrangement for differential pumping said chambers, the vacuum pumping arrangement comprising: a primary pump having an inlet connected for pumping a first of said vacuum chambers and an outlet for exhausting at or around atmosphere; a booster pump having an inlet connected for pumping a second of said vacuum chambers and an outlet connected to the inlet of the primary pump; and a secondary pump having an inlet connected for pumping a third of said vacuum chambers and an outlet connected to the inlet of the booster pump.

Other preferred and/or optional aspects of the invention are defined in the accompanying claims.

In order that the present invention may be well understood, an embodiment thereof, which is given by way of example only, will now be described with reference to the accompanying drawings, in which:

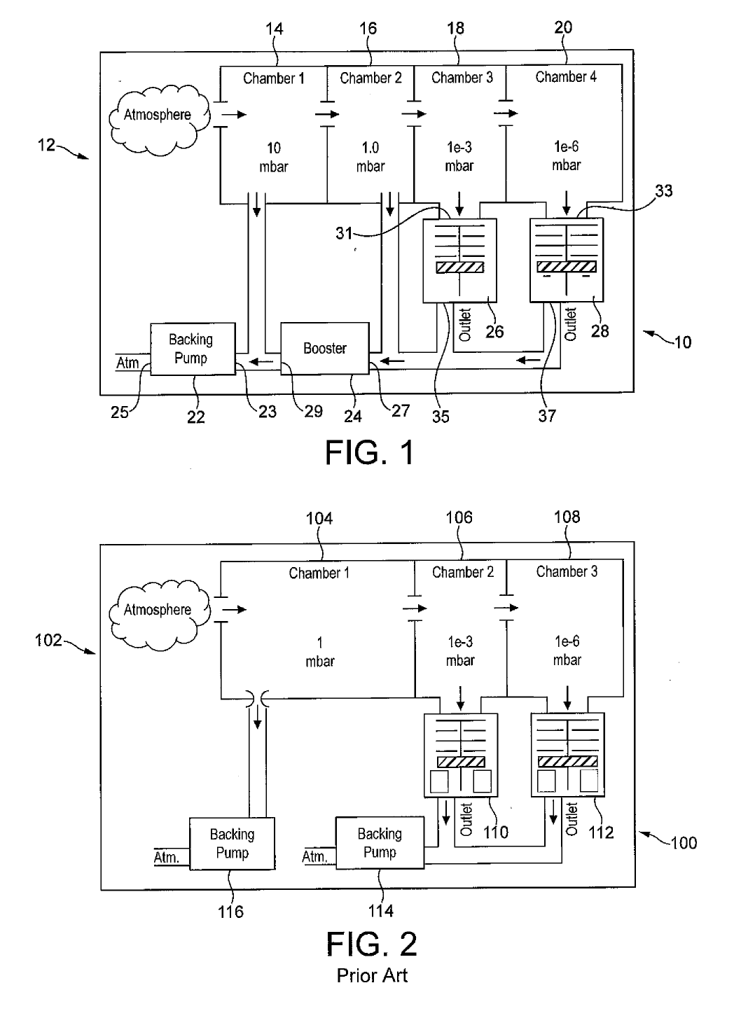

FIG. 1 shows schematically a vacuum system comprising a vacuum pumping arrangement; and

FIG. 2 shows schematically a prior art vacuum system comprising a vacuum pumping arrangement.

A vacuum pumping arrangement 10 is shown in FIG. 1. The pumping arrangement 10 is for differentially pumping a plurality of vacuum chambers in a vacuum system 12 such as a mass spectrometer system. The vacuum chambers are connected in series to provide a sample flow path starting from a first vacuum chamber 14 through a second vacuum chamber 16, a third vacuum chamber 18 to a fourth vacuum chamber 20. The pressure decreases along the sample flow path which flows to the right as shown in the Figure from atmosphere at the inlet of the first chamber 14 to high vacuum at the fourth chamber 20. For example, the first chamber 14 may be at a high pressure (low vacuum) such as 10 mbar. The second vacuum chamber may be at a relatively lower pressure of 1 mbar. The first and second vacuum chambers in this example are considered to be at a viscous, or non-molecular, regime or condition. The third vacuum chamber 18 may be at a low pressure of 10⁻³ mbar. The fourth vacuum chamber 20 is at a lower pressure of 10⁻⁶ mbar. The third and fourth chambers in this example are considered to be at a molecular flow regime or condition.

The vacuum pumping arrangement 10 is designed to differentially pump the vacuum chambers and maintain a relatively increased sample flow rate through the mass spectrometer compared to the prior art arrangement shown in FIG. 2. Furthermore, without increasing the number of pumps an increased number of vacuum chambers can be differentially pumped.

The vacuum pumping arrangement 10 comprises a primary, or backing, pump 22 having an inlet 23 which is connected to the first vacuum chamber 14 and an outlet 25 which exhausts at or around atmosphere. Pump 22 may be a scroll pump adapted for the pressure regime required in the first chamber and suitable for exhausting to atmosphere. A booster pump 24 has an inlet 27 which is connected to the second chamber 16. The booster pump has an outlet 29 which exhausts to the inlet of primary pump 22 and not to atmosphere. The booster pump 24 is not operating independently from the backing pump and is connected in series with the primary pump 22. At least one secondary pump is provided for pumping respective high vacuum chambers. In FIG. 1, two secondary pumps 26, 28 are shown in parallel having respective inlets 31, 33 connected for pumping the third vacuum chamber 18 and the fourth vacuum chamber 20. The outlets 35, 37 of the secondary pumps are connected to the inlet 27 of the booster pump. The secondary pumps 26, 28 are typically turbomolecular pumps and as such do not efficiently exhaust to atmosphere. Accordingly, the secondary pumps are backed by the booster pump 24 and the primary pump 22 connected in series.

A booster pump is configured for increased pumping capacity (speed) and decreased compression ratio. Accordingly, a suitable booster pump may be a scroll pump which is configured for increasing capacity. In this regard, a twin-start, or multi-start, scroll pump has an increased pumping capacity since two or more outer wraps of the scroll pump are connected to its inlet, each outer wrap principally adapted for increasing pumping capacity. As the outer wraps do not connect in series, as in a typical scroll pump, it does not achieve progressive compression of gas from outer wrap to the next one along a flow path and therefore compression ratio is reduced. Another example is a scroll pump without a tip seal as disclosed in the applicant's co-pending application GB 0914217.5. In known scroll pumps, a tip seal made usually of a plastics material, is received in channels formed in respective scroll walls for sealing between the scroll wall and an opposing scroll wall plate. The tip seals prevent back leakage of gas from a high pressure side of a scroll wall to a low pressure side of a scroll wall. As back leakage is reduced, higher compression ratios can be achieved. However, tip seals are contact seals and therefore increase power requirement of a pump caused by friction between moving surfaces. A suitable booster pump for FIG. 1 is a scroll pump without such tip seals. The absence of tip seals increases back leakage, which reduces the power required by the pump, especially at higher inlet pressures.

Such a scroll pump could be used in addition to or alternatively to a multi-start scroll pump. For example, a tip seal may be absent from the outer parallel wraps of the scroll pump but present in the compression stages of the pump.

Other suitable booster pumps will be known to those skilled in the art.

In more detail, the primary pump 22 is configured to provide a first compression ratio between its inlet and outlet. In FIG. 1, which shows the vacuum system in use, the first chamber is evacuated by the primary pump 22 to 10 mbar and the primary pump evacuates to atmosphere (1 bar). Therefore, the compression ratio of the primary pump is 100. The booster pump is configured to provide a second compression ratio between its inlet and outlet. In FIG. 1, the second chamber 16 is evacuated to 1 mbar and the booster pump exhausts to the inlet of the primary pump at 10 mbar. Therefore, the compression ratio of the booster pump 24 is 10. Accordingly, the compression ratio of the primary pump is larger than that of the booster pump, and in the example shown it is an order of magnitude larger.

The primary pump is also configured to provide a first pumping capacity, or speed, between its inlet and the outlet. In FIG. 1, the primary pump may have a pumping speed of 5800 sccm (standard cubic centimeters per minute). The booster pump is configured to provide a second pumping capacity between its inlet and outlet. In FIG. 1, the booster pump may have a pumping speed of 1600 sccm. The first pumping capacity is less than the second pumping capacity. There is a synergy between the primary pump and the booster which improves flow through the chambers and allows a further chamber to be pumped. In this regard, the flow from the first chamber to the second chamber is relatively high because the booster pump has a high pumping speed. Accordingly, the primary pump may be configured principally to achieve good compression ratio, since the required pumping speed is achieved by the booster pump. Similarly, the vacuum achieved in the first and second chambers is principally achieved by the primary pump so that the booster pump can be configured for increased pumping speed rather than compression ratio which may be allowed to fall. The primary pump and booster pump are connected in series for backing both the secondary pumps 26, 28. Accordingly, both secondary pumps are backed by both the primary and the booster pump. In the prior art, the secondary pumps are backed by a single primary pump 114. Additionally, the first chamber 104 is evacuated by a further primary pump 116. Both primary pumps 114 and 116 must be configured to achieve both compression ratio and required pumping speed. Accordingly, there is a certain amount of wasted effort in the prior art arrangement. In FIG. 1, the primary pump and booster pump function in synergy thereby reducing power requirement whilst also achieving together required compression ratio and required pumping speed.

The provision of booster pump 24 in series with a primary pump 22 for differentially pumping a plurality of vacuum chambers 14, 16 is advantageous for example in a mass spectrometer system. The booster pump can not only provide backing for secondary pumps 26, 28 but also provides high sample gas flow, particularly in the viscous pressure regime, and in more than one chamber in that regime.

In more detail, it is generally not possible for a single primary pump to pump a high pressure vacuum chamber and back a secondary pump because the pressure at the inlet necessary to pump the high pressure chamber is typically too high to back a secondary pump. Therefore, as shown in FIG. 2, two primary pumps are required. A first primary pump pumps the first vacuum chamber 104 and a second primary pump backs the secondary pumps.

In FIG. 1, the combination of a primary pump and a booster pump connected in series provides a number of advantages over the prior art. First, increased sample flow rate is achieved because the combination provides increased pumping capacity. Secondly, both the primary pump 22 and the booster pump 24 can be connected for pumping two vacuum chambers 14, 16. In the prior art, the two primary pumps are capable of pumping only one vacuum chamber. In this latter regard, the primary pump and booster pump combination is capable of pumping lower pressures at the inlet of the booster pump than is possible at either of the primary pumps shown in FIG. 2. Therefore, the inlet of the booster pump can be connected both to a vacuum chamber and to back the secondary pumps. A further advantage is that an additional differentially pumped chamber can be provided in the system compared to the prior art whilst using the same number of pumps as in the prior art.

Unlike the prior art pumping arrangement shown in FIG. 2, the use of a booster pump offers increased pumping performance without significant increase in power consumption or physical size of the vacuum pumping arrangement.

1. A vacuum system comprising a plurality of vacuum chambers connected in series and a vacuum pumping arrangement for differential pumping said chambers, the vacuum pumping arrangement comprising: a primary pump having an inlet connected for pumping a first of said vacuum chambers and an outlet for exhausting at or around atmosphere; a booster pump having an inlet connected for pumping a second of said vacuum chambers and an outlet connected to the inlet of the primary pump; and a secondary pump having an inlet connected for pumping a third of said vacuum chambers and an outlet connected to the inlet of the booster pump.

2. A vacuum system as claimed in claim 1, comprising two secondary pumps for pumping the third and a fourth of said vacuum chambers, respectively, the outlets of said two secondary pumps being connected to the inlet of the booster pump.

3. A vacuum system as claimed in claim 2, wherein the vacuum chambers are connected to allow fluid flow through the chambers in order from the first vacuum chamber.

4. A vacuum system as claimed in claim 3, wherein the primary pump and the booster pump are configured to pump respective first and second chambers at a low vacuum at which viscous flow occurs in at least the first chamber.

5. A vacuum system as claimed in claim 4, wherein the primary pump is configured to provide a first compression ratio between the inlet and the outlet thereof and the booster pump is configured to provide a second compression ratio between the inlet and the outlet thereof and the first compression ration is larger than the second compression ratio.

6. A vacuum system as claimed in claim 5, wherein the primary pump is configured to provide a first pumping capacity between the inlet and the outlet thereof and the booster pump is configured to provide a second pumping capacity between the inlet and the outlet thereof and the first pumping capacity is less than the second pumping capacity.

7. A vacuum system as claimed in any of the preceding claims, wherein the booster pump is a scroll pump configured for increased pumping capacity and decreased compression ratio.

8. A vacuum system as claimed in claim 7, wherein the scroll pump is a multi-start scroll pump and/or a scroll pump without tip seals over at least part of the extent of the co-operating scroll walls thereof.

9. A mass spectrometer system in accordance with the vacuum system as claimed in any one of the preceding claims.
